(19) United States
(12) Patent Application Publication
(10) Pub. No.: US 2023/0140297 A1
(43) Pub. Date: May 4, 2023

(54) METHOD FOR MANUFACTURING BRAKE PAD

(71) Applicant: FINETRO CO., LTD., Chungcheongnam-do (KR)

(72) Inventors: Won-Bong CHO, Asan-si (KR); Sung-Ki LEE, Gunsan-si (KR); Yun-Hee KWON, Yongin-si (KR)

(21) Appl. No.: 17/931,713

(22) Filed: Sep. 13, 2022

(30) Foreign Application Priority Data
Nov. 2, 2021 (KR) 10-2021-0148972

(51) Int. Cl. B29C 43/20; B29B 11/12; B29C 43/18; B29C 43/52

(52) U.S. Cl. CPC B29C 43/203; B29B 11/12; B29C 43/18; B29C 43/52; B29L 2031/16; F16D 2200/0034; F16D 2250/0061

(57) ABSTRACT

Provided is a method for manufacturing a brake pad used in a brake of a vehicle, which is capable of improving a limitation of separation of a friction material and a back plate of the brake pad. The method for manufacturing the brake pad includes manufacturing an intermediate plate and integrally pressing and molding a back plate and a friction material on both surfaces with the intermediate plate manufactured in a mold therebetween so that the back plate and the friction material are integrally coupled to each other by using the intermediate plate as a medium to manufacture the brake pad.

### BACKGROUND

The present invention relates to a method for manufacturing a brake pad, and more particularly, to a method for manufacturing a brake pad used in a brake of a vehicle, which is capable of improving a limitation of separation of a friction material and a back plate of the brake pad.

In general, a brake is an important device used to decelerate or stop a vehicle during driving, and a disc brake and a drum break, which are hydraulic brakes, are being widely used. Recently, in order to improve braking performance in accordance with the trend of high-speed vehicles, disc brakes having less decrease in braking force due to heat dissipation and thermal deformation compared to drum brakes are being widely used.

A disc brake is a brake device that generates braking force by allowing brake pads to forcibly come into close contact with both surfaces of the disc to stop the rotation of the disc, thereby braking the vehicle and includes a disc rotating integrally with the vehicle wheel and a caliper unit pressing the brake pad against the disc to brake the disc by frictional force.

FIG. 1 is a cross-sectional view illustrating a known caliper unit, and FIG. 2 is a front view illustrating a coupling state of a torque member and a brake pad in the known caliper unit.

In constituents of the disc brake, as illustrated in FIG. 1, a caliper unit 10 includes a torque member (also referred to as a ‘carrier’) fixed to a vehicle body, a brake pad 12 disposed inside the torque member 11 and pressing each of both surfaces of the disc 1 to generate braking force, and a caliper housing (also referred to as a ‘piston housing’) coupled to the torque member 11 by using a sliding pin 14 as a medium.

Here, the brake hydraulic pressure generated by a master cylinder during the braking is applied to a cylinder 15 of the caliper housing (piston housing) 13.

In addition, a piston 16 for transmitting the applied brake hydraulic pressure to an inner pad 12 is installed in the cylinder 15 of the caliper housing 13, and a reaction force support part (also referred to as a ‘finger part’) is disposed at an opposite side of the cylinder 15 and the piston 16 in the caliper housing 13.

The brake pad is constituted by an inner pad 12 disposed at a side of the piston 16 and an outer pad (not shown) disposed at an opposite side of the inner pad 12 with respect to the disc 1, and the torque member 1 is installed so that the inner pad 12 and the outer pad are disposed with the disc 1 therebetween.

In FIGS. 1 and 2, in the case of the outer pad disposed at the opposite side of the inner pad 12 with the disc 1 therebetween is hidden by the disc 1 and thus is not shown.

Each of both the inner pad 12 and the outer pad is coupled to the torque member 11 to move forward and backward. For this, a sliding protrusion 17 is disposed on each of the pads 12, and a guide groove 18, into which the sliding protrusion 17 is inserted to be slidable, is defined in a position of the torque member 11, which corresponds to the sliding protrusion.

Thus, while the sliding protrusion 17 is slid in a state of being inserted into the guide groove 18 of the torque member 11, the pad 12 moves in a direction, in which the disc 1 is pressed, or moves in a direction, in which the pressing of the disc is released.

When the brake hydraulic pressure generated by the master cylinder is applied to the cylinder 15 of the caliper housing 13, the piston advances by the brake hydraulic pressure to press the inner pad 12. Here, the inner pad 1 is in close contact with the disc 1, and also, the caliper housing 13 moves due to the reaction between the inner pad 12 and the disc 1 so that the outer pad disposed at the opposite side of the inner pad 12 is in close contact with the disc 1 through the reaction force support part.

As a result, the two pads press and clamp the disc while being in close contact with both surfaces of the disc, and braking force (braking torque) is generated to brake the vehicle by frictional force between the pads and both sides of the disc.

In an electrified vehicle (motor-driven vehicle) that is driven by a motor, such as a hybrid electric vehicle, a battery electric vehicle (BEV), or a fuel cell electric vehicle (FCEV), a regenerative mode is performed, in which vehicle kinetic energy is recovered as electric energy through a power generation operation of the motor during coasting or braking to charge the battery. In an electrified vehicle, a function of the regenerative mode is essential to improve vehicle efficiency and fuel efficiency.

In this manner, in the electrified vehicle that is driven by the motor, when decelerating, regenerative braking by the motor together with friction braking (hydraulic braking) by the existing brake is performed by the motor may be performed, and the braking force required by the vehicle may be satisfied with the regenerative braking and the friction braking (hydraulic braking).

Therefore, in the case of the electrified vehicle, it is seen that a braking environment capable of reducing a braking capacity of the brake when compared to the general internal combustion engine vehicle without a motor has been established. As a result, the need to develop a compact brake optimized for a regenerative braking system of a platform dedicated to the electrified vehicle is emerging.

When the vehicle is decelerated during the driving, an amount of braking force varies depending on the driving environment on the road. However, in most cases, the vehicle slowly and smoothly decelerated through gradual braking rather than sudden braking. In the case of the electrified vehicle, the regenerative braking may be performed to decelerate the vehicle by generating generation resistance in the driving motor during the deceleration, and a significant portion of the total braking force required during the deceleration may be covered by the regenerative braking force.

Thus, in the vehicle in which the regenerative braking by the motor is performed, a replacement cycle of a friction material used during friction braking may increase, and as the use of the friction braking is greatly reduced in the electric vehicle, rust occurs on a surface of the brake disc (rotor).

As a result, the point in time when the sales volume of the electrified vehicles becomes larger than that of the internal combustion engine vehicles is also expected to arrive soon. Therefore, it is necessary to develop a dedicated brake that meets and optimizes the braking force required for the electrified vehicle.

In addition, the caliper unit 10 illustrated in FIGS. 1 and 2 has been used in the existing internal combustion engine vehicle in which 100% friction braking is performed, and since a size of the pad 12 and a friction area between the pad and the disc 1 are greater than an area of a piston, vibration (oscillation) may occur in a disc and a pad during braking.

FIGS. 3 and 4 are views for explaining limitations of the brake pad in accordance with the prior art. In FIGS. 3 and 4, reference numerals ‘12a’ and ‘12b’ denote a back plate and a friction material constituting the pad 12, respectively.

As illustrated in the drawings, in the caliper unit, the size and area of the pad 12 are very large when compared to a size and cross-sectional area of the piston in the cylinder (referred to as reference numeral ‘16’ in FIG. 1), and the braking pressure acts directly from the piston to the pad on a central area of the pad 12 that is in contact with the piston 16, but reaction force acting in a direction that is opposite to the direction, in which the force applied by the piston acts, acts on the area on which the piston is not in contact with the piston during the repeated braking at high deceleration, in particular, at both ends of the pad because coupling strength of the friction material is weakened due to an increase in temperature of the friction material (see FIG. 3).

Thus, more abrasion may occur on the central area of the pad 12 than other portions due to the friction with the disc 1, and as a result, a peel-off phenomenon may occur between the central area of the pad 12, in which abrasion is relatively high in the brake-off state, and the brake disc 1 during the driving of the vehicle (see FIG. 4). As a result, judder and noise may occur greatly when a braking torque is fluctuated due to non-uniformity of a contact surface pressure between the disc and the pad during the braking.

In addition, since high-pressure braking pressure is required during high-speed wet braking due to the peel-off phenomenon between the disc and the friction material while driving (the brake is not working), even when the brake pedal is pressed, the brake pad does not sufficiently press the disc by consuming a brake fluid discharged from a brake master cylinder that generates the braking pressure, resulting in increasing a braking distance.

In order to solve this limitation, a compact type caliper unit in which sizes of a torque member and a brake pad are reduced is being developed. The compact caliper unit is reduced in braking force when compared to the caliper unit of the existing internal combustion engine vehicle (general engine vehicle), but has a compact configuration. Thus, the compact caliper unit is useful in electrified vehicles, to which the regenerative braking system is applied, by exerting reliable braking power for high-speed repetitive braking even under extreme braking conditions because there is no peel-off phenomenon of the disc and the friction surface.

However, it is necessary to improve the limitation the back plate 12a constituting the brake pad 12 and the friction material 12b are separated from each other in the compact caliper unit.

In this regard, since the use of friction braking is reduced in the electrified vehicle in which the regenerative braking is performed, a replacement cycle of the brake pad 12 including the friction material 12b greatly increases. However, if the brake pad 12 is used for a long time in accordance with the increasing replacement cycle, the peel-off phenomenon may occur between the bonding surface of the back plate 12a and the friction material 12b of the brake pad 12.

Furthermore, as the replacement cycle of the brake pad 12 increases, if the brake pad is used for a long time without replacing the brake pad 12, the separation between both the bonding surfaces may progress for a long time due to corrosion and the like, and thus, the friction material 12b may be separated from the back plate 12a.

As described above, when the back plate 12a and the friction material 12b of the brake pad 12 are separated from each other, a braking inability situation may occur while driving the vehicle to significantly threaten driving stability, as well as serious vehicle accidents and fatal human accidents.

### SUMMARY

The present invention provides a method for manufacturing a brake pad used in a brake of a vehicle, which is capable of improving a limitation of separation of a friction material and a back plate of the brake pad.

The object of the present invention is not limited to the object mentioned above, and other objects not mentioned will be clearly understood by those of ordinary skill in the art (hereinafter, referred to as ‘person of ordinary skill’) from the description below.

In accordance with the present invention, a method for manufacturing a brake pad includes: manufacturing an intermediate plate; and integrally pressing and molding a back plate and a friction material on both surfaces with the intermediate plate manufactured in a mold therebetween so that the back plate and the friction material are integrally coupled to each other by using the intermediate plate as a medium to manufacture the brake pad.

The back plate may be preliminarily molded using a polymer synthetic resin so as to be integrally coupled to one surface of the manufactured intermediate plate, in a state in which the preliminarily molded back plate and the intermediate plate are installed in one mold of an upper mold and a lower mold, a raw material of the friction material may be filled into the other mold of the upper mold and the lower mold, and after the one mold and the other mold are coupled to each other, the back plate and the friction material may be heated, pressed, and molded at a predetermined temperature so that the back plate and the friction material are integrally coupled on both the surfaces of the intermediate plate.

The back plate may be manufactured by being pressed and molded using engineering plastics as the polymer synthetic resin.

The back plate and the friction material may be pressed and molded with the intermediate plate therebetween and be thermally treated at a set temperature for a set time to manufacture the brake pad in which the back plate, the intermediate plate, and the friction material are integrally coupled to each other.

The intermediate plate may include: a front part that is a portion interposed between a surface of the back plate and a surface of the friction material; and a side surface cover part integrally disposed along an entire circumference of an edge of the front part to cover a surface of the front part on the entire circumferential of the edge of the back plate, wherein a cross-section of the front part, on which the surface of the back plate and the surface of the friction material are bonded to be in close contact with each other, may have a shape in which an unevenness is repeated to increase in bonding force between the surface of the back plate and the surface of the fraction material.

### BRIEF DESCRIPTION OF THE DRAWINGS

Exemplary embodiments can be understood in more detail from the following description taken in conjunction with the accompanying drawings, in which:

FIG. 1 is a cross-sectional view illustrating a general caliper unit;

FIG. 2 is a front view illustrating a coupling state of a torque member and a brake pad in the known caliper unit;

FIGS. 3 and 4 are views for explaining limitations of the brake pad in accordance with the prior art;

FIG. 5 is a front view illustrating a coupling state of a torque member and a brake pad in a compact caliper unit, in which the brake pad manufactured in accordance with the present invention is used;

FIG. 6 is a cross-sectional view illustrating a state in which a disc is pressed by a piston, a pad, and a friction material in the compact caliper unit, in which the brake pad manufactured in accordance with the present invention is used;

FIG. 7 is a cross-sectional view taken along line A-A′ of FIG. 6; and

FIG. 8 is a cross-sectional view illustrating a shape in cross-section of an intermediate plate in the brake pad manufactured in accordance with the present invention; and

FIG. 9 is a cross-sectional view for explaining a method for manufacturing a brake pad in accordance with the present invention.

### DETAILED DESCRIPTION OF EMBODIMENTS

Specific structural or functional descriptions disclosed in the embodiment of the present invention are only exemplified for the purpose of explaining the embodiments in accordance with the concept of the present invention, and the embodiments in accordance with the concept of the present invention may be implemented in various forms. In addition, it should not be construed as being limited to the embodiments described herein, and it should be understood to include all modifications, equivalents and substitutes included in the spirit and scope of the present invention.

In the present invention, terms such as ‘first’, ‘and/or’ ‘second’ may be used to describe various components, but the components are not limited to the above terms. The above terms are used only for the purpose of distinguishing one component from other components, for example, within the scope not departing from the scope of the rights in accordance with the concept of the present invention, the first component may be named as the second component, similarly, the second component may also be referred to as a first component.

It will also be understood that when a component is referred to as being “‘connected to” or “in contact with” another component, it can be directly connected to the other component, or intervening components may also be present. It will also be understood that when an component is referred to as being ‘directly connected to’ or ‘in direct contact with’ another component, there is no intervening components. Other expressions for describing the relationship between components, that is, expressions such as “between” and “immediately between” or “adjacent to” and “directly adjacent to”, should be interpreted similarly.

The same reference numerals represent the same components throughout the specification. In the following description, the technical terms are used only for explaining a specific embodiment while not limiting the present invention. In this specification the terms of a singular form may include plural forms unless specifically mentioned. As used in this specification, the meaning of ‘includes (comprises)’ and/or ‘including (comprising)’ specifies a component, a step, an operation and/or an component does not exclude other components, steps, operations and/or components.

Hereinafter, embodiments will be described in detail with reference to the accompanying drawings.

The present invention relates to a method for manufacturing a brake pad, and more particularly, to a method for manufacturing a brake pad used in a brake of a vehicle, which is capable of improving a limitation of separation of a friction material and a back plate of the brake pad.

The manufacturing method in accordance with the present invention may be applied to manufacture a brake pad of an existing brake. For example, the manufacturing method may be applied to manufacturing a brake pad of a brake mounted on an existing internal combustion engine vehicle.

Furthermore, the manufacturing method in accordance with the present invention may also be applied to manufacture a brake pad of a compact type caliper unit capable of reducing a size, weight, and cost of a component and improving fuel efficiency.

Here, the compact caliper unit may be applied to an electrified vehicle in which regenerative braking is performed by a motor while driven using the motor, such as an electric vehicle in a broad sense, that is, a hybrid vehicle (HEV), a pure electric vehicle (BEV), or a fuel cell vehicle (FCEV).

Since the compact caliper unit is reduced in braking force when compared to the caliper unit of the internal combustion engine vehicle (general engine vehicle) in accordance with the prior art, but has a compact configuration, the caliper unit is useful in the electrified vehicle to which the regenerative braking system is applied.

In the electrified vehicle capable of performing the regenerative braking by the motor, total braking torque is satisfied by hydraulic braking torque (friction braking torque) by the brake and the regenerative braking torque by the motor.

Therefore, unlike the general internal combustion engine vehicle in which the regenerative braking is impossible, and thus, the total braking torque has to be borne by the hydraulic braking torque, in the electrified vehicle capable of performing the regenerative braking, the regenerative braking torque partially shares the total braking torque, and thus, a braking capacity of the generating brake generating the hydraulic braking torque may be reduced.

Thus, when compared to the prior art, the braking capacity may be reduced, but the caliper unit having a compact configuration may be mounted on the vehicle so as to be used. In particular, the caliper unit may be used in the electrified vehicle, in which the regenerative braking is performed, and the braking capacity of the hydraulic brake is reduced.

Before describing the method of manufacturing the brake pad in accordance with the present invention, to help the understanding of the brake pad of the compact caliper unit capable of being manufactured in accordance with an embodiment, the compact caliper unit will be described first.

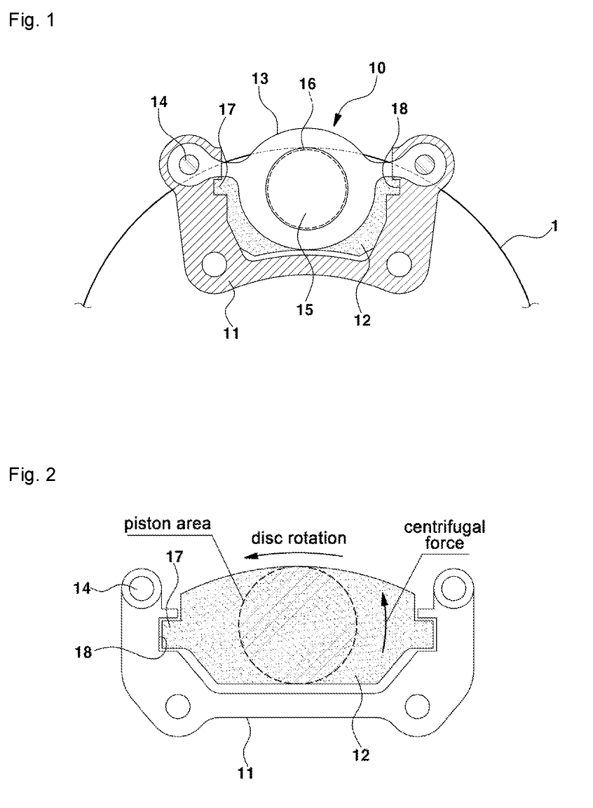

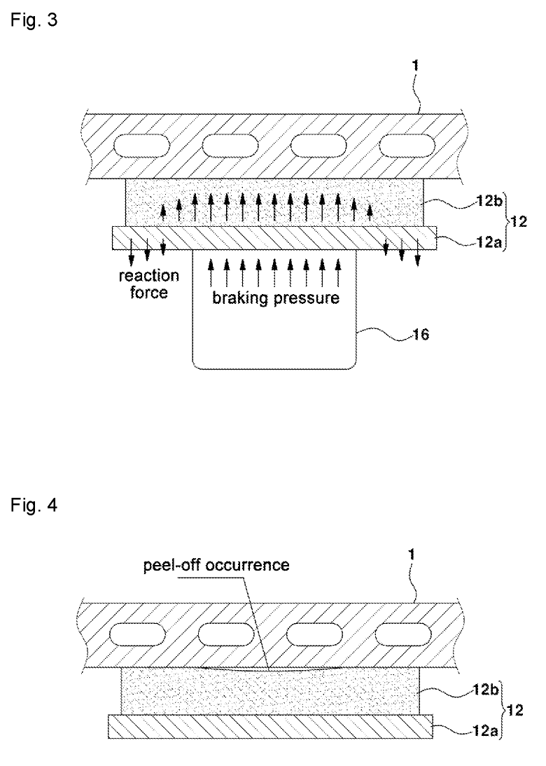

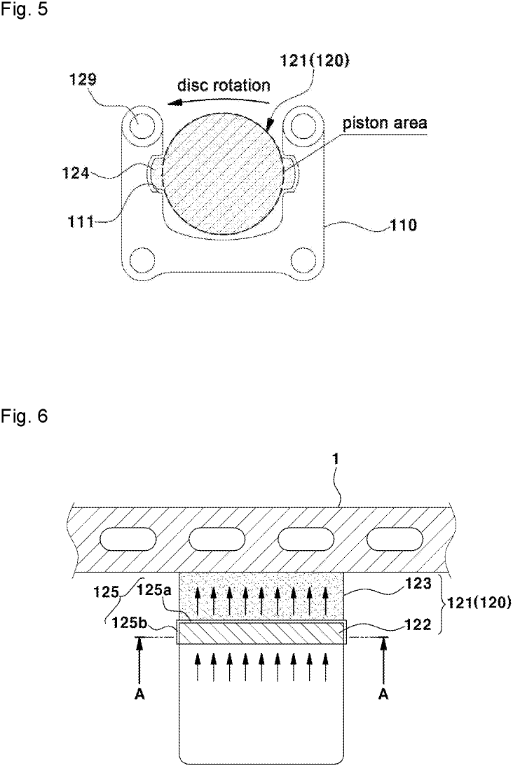

FIG. 5 is a front view illustrating a coupling state of a torque member and a brake pad in a compact caliper unit, in which the brake pad manufactured in accordance with the present invention is used. The compact caliper unit includes a torque member 110 fixed to a vehicle body, a brake pad 120 disposed inside the torque member 110 and pressing both surfaces of a disc (referred to as reference numeral ‘1’ in FIG. 1) to generate braking force, and a caliper housing (referred to as reference numeral ‘13’ in FIG. 1) coupled to the torque member 110 by using a sliding pin 129 as a medium.

Here, the brake hydraulic pressure generated by the master cylinder during the braking is applied to the cylinder (referred to as reference numeral ‘15’ in FIG. 1) of the caliper housing. In addition, the piston (referred to as reference numeral ‘16’ in FIG. 1) that transmits the applied brake hydraulic pressure to the brake pad (an inner pad) 120 is installed in the cylinder of the caliper housing, and a reaction force support part (also referred to as a ‘finger part’) is disposed at an opposite side of the cylinder and the piston in the caliper housing.

The brake pad 120 is manufactured through a manufacturing method in accordance with an embodiment and is constituted by the inner pad 121 disposed at a side of the piston and the outer pad (not shown) disposed at an opposite side of the inner pad with respect to the disc. Here, the caliper unit is the same the caliper unit in accordance with the prior art in that the inner pad and the outer pad are installed on the torque member with the disc therebetween.

The brake pad 120 illustrated in FIG. 5 may be the inner pad 121 pressed by the piston, and the outer pad may have the same shape as that of the inner pad although not illustrated in FIG. 5. As illustrated in FIG. 5, in the compact caliper unit, a left and right length of the brake pad 120, i.e., a left and right length of the inner pad 121 and the outer pad are significantly reduced.

In addition, in the compact caliper unit, in the inner pad 121 and the outer pad, sliding protrusions may have the same shape, and a back plate 122, a friction material 123, and an intermediate plate 125, which will be described later, may have the same configuration. In addition, guide grooves 111 of the torque member 110, to which the sliding protrusions of the two pads are coupled, respectively, may also have the same shape.

In the caliper unit in accordance with the prior art, each of the inner pad and the outer pad has a long left and right length and a predetermined length as illustrated in FIG. 2. However, in the compact caliper unit, each of the inner pad 121 and the outer pad may have a shape similar to that of an approximately cross-section of the piston (or a shape of a contact surface with the pad, which is shape indicated as ‘piston area’ in FIG. 5).

That is, if the cross-sectional shape of the piston is circular, the overall shape of each of the inner pad 121 and the outer pad may also be circular. A diameter of the inner pad 121 may be the same as that of the piston or be greater from that of the piston by a difference within a set range so that the entire area of the piston evenly contacts and presses the inner pad during the braking.

In this case, the outer pad (not shown) may be provided to have the same diameter and shape as the inner pad 121. As a result, in the compact caliper unit, a size and weight of each of the inner pad and the outer pad may be reduced when compared to the prior art, and thus, the shape and size of the pad may be optimized in the vehicle in which the regenerative braking is performed. In addition, as seen from FIG. 5, since a distance between the two pin holes at both sides to which the sliding pin 129 is coupled in the torque member 110 may be reduced, the overall size and weight of the torque member may also be reduced.

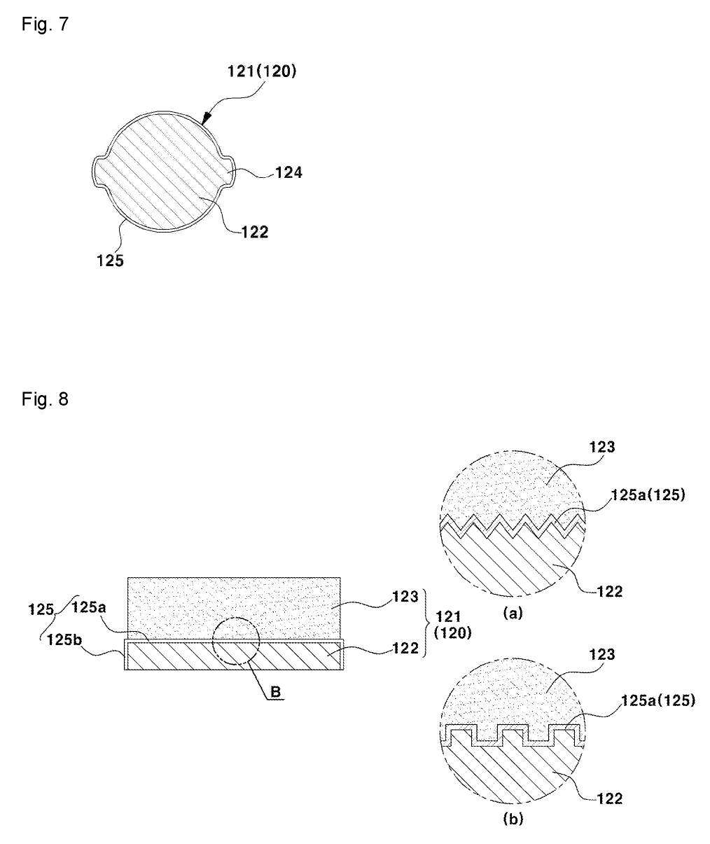

FIG. 6 is a cross-sectional view illustrating a state in which a disc is pressed by a piston, a pad, and a friction material in the compact caliper unit, in which the brake pad manufactured in accordance with the present invention is used, and FIG. 7 is a cross-sectional view taken along line A-A′ of FIG. 6. As illustrated in the drawings, the brake pad 120, i.e., each of the inner pad 121 and the outer pad (not shown) include a back plate 122 and a friction material 123 integrally coupled to the back plate 122 with an intermediate plate, which will be described later, therebetween. Among them, the friction material 1230 is a portion that actually contacts and presses the brake disc and generates braking force through friction with the disc.

Referring to FIG. 6, a shape of the pad 120, i.e., the overall shape of the back plate 122 and the friction material 123 is the same circular shape as the cross-sectional shape of the piston 16 (or the shape of the contact surface with the pad). In this case, a diameter of the back plate 122 and the friction material 123 of the pad may also be the same as that of the piston 16 or be greater than that of the piston 16 by a difference with a set range.

As a result, a size of a pressing surface of the piston 16 and a size of a contact surface of the pad 120 with which the piston 16 is in contact may have the same or similar, and thus the braking pressure (brake hydraulic pressure) transmitted through the piston 16 may be uniformly distributed to the back plate 122 and the friction material 123. Furthermore, as the distribution of the braking pressure is uniform, vibration and noise generation during the braking may be reduced, and as an abrasion surface of the friction material is uniform, a frequency and degree of braking vibration may be significantly reduced.

In addition, in the compact caliper unit, the sliding protrusions 124 may be disposed at both sides of the pad 120, and also, the sliding protrusions 124 at both the sides may be inserted into and coupled to the guide grooves 111 of the torque member 110. An outer surface of each of the sliding protrusions 124 may have an arc shape. In this case, an inner surface of each of the guide grooves 111 at both the sides may also have an arc shape as illustrated in FIG. 5.

As a result, arc-shaped sliding contact may be provided between each of the sliding protrusions 124 at both the sides of the pad 120 and the inner surface of each of the guide grooves 111 of the torque member 110. Thus, when abnormal torque occurs, the abnormal torque may be resolved, and also, a frequency of occurrence of noise may be significantly reduced.

Referring to FIG. 5, it is seen that a clearance exists between a surface of the sliding protrusion and the inner surface of the guide groove, and thus, the sliding protrusion of the pad may be slid inside the guide groove of the torque member.

In addition, in the caliper unit in accordance with the prior art, the back plate of the pad is made of steel to minimize deformation, but in an embodiment, the back plate 122 of the pad 120 may be made of engineering plastics having excellent strength.

In addition, in the compact caliper unit, the shape of the pad 120 and the disc contact area of the pad are similar to the shape of the piston 16 and the pad contact area of the piston 16, and thus, when the braking pressure is applied to the back plate 122 of the pad, only pressing force is generated between the piston 16, the friction material 123, and the disc 1 without share lateral-force is generated in the back plate. As a result, like this embodiment, engineering plastics having excellent pressing resistance may be adopted as a material of the back plate 122.

Also, in an embodiment, the back plate 122 made of the engineering plastic material and the friction material 123 may be molded integrally to manufacture the brake pad 120, thereby solving the limitation in which the back plate 122 and the friction material 123 are separated from each other.

In addition, in the brake pad 120 in accordance with an embodiment, the intermediate plate 125 may be integrally attached and fixed between the back plate 122 and the friction material 123. Here, the intermediate plate 125 may cover an interface between the back plate 122 and the friction material 123 and an entire circumferential surface of a side end of the back plate 122.

As described above, the intermediate plate 125 is provided in a thin plate structure and installed to surround surfaces of front and side surfaces of the back plate 122. The intermediate plate 125 is constituted by a front part 125a that is a portion disposed between the back plate 122 and the friction material 123 and a side surface cover part 125b integrally provided along the entire circumference of an edge of the front part 125a to cover the surface of the side surface of the back plate.

The intermediate plate 125 may be made of a steel alloy material and may serve to uniformly transmit frictional heat generated between the disc and the friction material 123 of the pad 120 during the braking to the back plate 122 made of the engineering plastic and simultaneously serve as a heat dissipation plate to dissipate a portion of the frictional heat to air through the side surface cover part 125b and also serve to reinforce strength of the back plate 122.

In addition, the intermediate plate 125 may be attached to surround the surface of the sliding protrusion 124 protruding from the back plate 122 to both left and right sides. Here, a portion of the intermediate plate 125, which surrounds the sliding protrusion 124 of the back plate 122 may prevent abrasion (abrasion of the sliding protrusion) of the back plate 122 when the sliding protrusion 124 slidably contacts along an inner surface of the guide groove 111 of the torque member 110 during the braking to secure abrasion resistance performance.

FIG. 8 is a cross-sectional view illustrating a shape in cross-section of an intermediate plate in the brake pad manufactured in accordance with an embodiment. As illustrated in the drawing, a cross-section of the front portion 125a of the intermediate plate 125 may have a shape in which a concave-convex shaped part is repeated to increase in bonding force and coupling force between both the sides while increasing in contact area between the intermediate plate 125 and the back plate 122 and between the intermediate plate 125 and the friction material 123. Referring to FIG. 8, an example in which the cross-section of the front part 125a of the intermediate plate 125 has a triangular teeth shape in which a mountain-valley shaped unevenness is repeated, or a square teeth shape in which concave and convex shapes are repeated is illustrated.

Here, even if the cross-section of the intermediate plate 125 has the repeatedly bent shape, both surfaces of the intermediate plate, the back plate 122, and the friction material 123 are coupled to each other so as not to occur a clearance therebetween and so as to be completely in close contact with each other on the entire surface. For this, the pad 120 is manufactured so that the back plate 122 and the friction material 123 are in close contact with each other on both the surfaces of the intermediate plate 125. Here, after the intermediate plate 125 is manufactured so that the cross-section has a shape in which the unevenness is repeated, the back plate 122 and the friction material 123 are thermally molded on both the surfaces of the intermediate plate so as to be mechanically coupled to each other.

In an area on which calcium chloride is widely sprayed on roads to remove snow in winter, there is a possibility that separation may occur due to corrosion of the contact surface between the back plate 122, the intermediate plate 125, and the friction material 123. However, when the intermediate plate 125 is manufactured in cross-section having the bent shape as described above in a state in which the replacement cycle of the pad 120 increases, and the back plate 122 and the friction material 123 are press-molded on both the surfaces of the intermediate plate so as to be mechanically coupled to each other, the above-described separation may be solved.

Hereinafter, a method for manufacturing a brake disc in accordance with the present invention will be described in more detail.

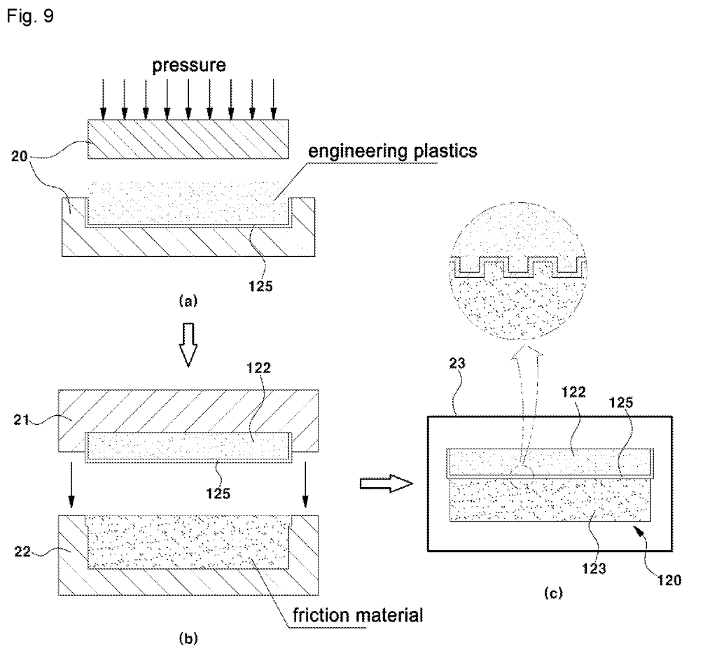

FIG. 9 is a cross-sectional view for explaining a method for manufacturing a brake pad in accordance with the present invention.

In the prior art, a steel (iron alloy) material is subjected to surface treatment to prevent corrosion from occurring, and an adhesive is applied to a surface of a back plate to bond a friction material, and then, the friction material is pressed and molded onto the surface of the back plate to manufacture a brake pad.

On the other hand, in the present invention, the back plate may be manufactured using a polymer synthetic resin instead of the steel material, and also, the back plate may be manufactured using engineering plastics. Here, as the engineering plastics capable of used for manufacturing the back plate, one of the known engineering plastics such as polyamide, polyacetal, an acrylonitrile-butadiene-styrene copolymer (ABS) resin, polycarbonate, and polybutylene terephthalate may be optionally used.

As described above, when the back plate is manufactured using the engineering plastics instead of the steel material, a weight may be reduced, and the brake pad may be manufactured by integrally pressing and molding the back plate and the friction material under the same ambient temperature. In this case, the configuration, shape, and structure of the brake pad may be the same as those illustrated in FIGS. 6 to 8.

When the process of manufacturing the brake pad is described in more detail with reference to the drawings, as illustrated (a) of in FIG. 9, the intermediate plate 125 is manufactured using a steel alloy and then is pressed onto a pressing mold 20 together with the intermediate plate 125, which is manufactured using the engineering plastics at room temperature, to preliminarily mold a back plate 122 integral with the intermediate plate 125.

Thereafter, as illustrated in (b) of FIG. 9, the preliminarily molded back plate 122 and the intermediate plate 125 integrally coupled to the back plate 122 are installed in the mold 21, and then, a friction material 123 is heated and simultaneously pressed and molded so that the back plate 122 and the intermediate plate 125 are integrated with each other within the mold 22 at the same temperature to manufacture the brake pad 120, in which the back plate 122, the friction material 123, and the intermediate plate 125 are integrated with each other.

Here, the preliminarily molded back plate 122 is inserted and installed into an upper mold 21 so as to be integrally coupled to the intermediate plate 125, and then a raw material of the friction material is put into a cavity of a lower mold 22. Thereafter, the upper mold and the lower mold, which are maintained at the same temperature, are coupled to each other to perform the heating, pressing, and molding so that the back plate 122 and the friction material 123 are integrally coupled to each other. During the pressing and molding, a heating temperature through the molds 21 and 22 is made to be about 100° C. to about 200° C., and the preliminarily molded back plate and the friction material may be heated, pressed, and molded at the same temperature in the mold having the same temperature.

Thereafter, the back plate 122 and the friction material 123, which are integrated with each other, are thermally treated under the same temperature condition to fix mechanical properties of the back plate and the friction material of the pressed and molded brake pad. During the heat-treatment, as illustrated in (c) of FIG. 9, the pressed and molded brake pad, i.e., the brake pad 120, in which the back plate 122, the intermediate plate 125, and the friction material 123 are integrally coupled to each other, is disposed in a furnace for the heat-treatment 23 to perform soaking heat-treatment at a set temperature for a set time.

Here, the heat-treatment is performed in the heat-treatment furnace 23 at a temperature of about 140° C. to about 250° C. for about 5 hours to about 15 hours, and after the heat-treatment is completed, the brake pad 120 is cooled to obtain a finished brake pad 120. During the cooling, the brake pad 120 may be air-cooled for about 2 hours to about 4 hours until the temperature is about 80° C. or less.

Therefore, in the method for manufacturing the brake pad in accordance with the present invention, the brake pad may be manufactured in the manner, in which the back plate made of the engineering plastics is thermally pressed and molded integrally together with the friction material, to improve the coupling force and coupling strength between the back plate and the friction material, which are coupled to each other with the intermediate plate therebetween. As a result, the replacement cycle of the brake pad may increase, and also, the braking performance and the driving stability of the vehicle may be improved to solve the limitations of the braking inability and the occurrence of the accidents.

Therefore, in the method for manufacturing the brake pad in accordance with the present invention, the brake pad may be manufactured in the manner, in which the back plate made of the engineering plastics is thermally pressed and molded integrally together with the friction material, to improve the coupling force and coupling strength between the back plate and the friction material, which are coupled to each other with the intermediate plate therebetween. As a result, the replacement cycle of the brake pad may increase, and also, the braking performance and the driving stability of the vehicle may be improved to solve the limitations of the braking inability and the occurrence of the accidents.

Although preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments of the present invention are disclosed only for illustrative purposes and should not be construed as limiting the present invention.

What is claimed is:

1. A method for manufacturing a brake pad, the method comprising:
manufacturing an intermediate plate; and
integrally pressing and molding a back plate and a friction material on both surfaces with the intermediate plate manufactured in a mold therebetween so that the back plate and the friction material are integrally coupled to each other by using the intermediate plate as a medium to manufacture the brake pad.

2. The method of claim 1, wherein the back plate is preliminarily molded using a polymer synthetic resin so as to be integrally coupled to one surface of the manufactured intermediate plate,
in a state in which the preliminarily molded back plate and the intermediate plate are installed in one mold of an upper mold and a lower mold, a raw material of the friction material is filled into the other mold of the upper mold and the lower mold, and
after the one mold and the other mold are coupled to each other, the back plate and the friction material are heated, pressed, and molded at a predetermined temperature so that the back plate and the friction material are integrally coupled on both the surfaces of the intermediate plate.

3. The method of claim 1, wherein the back plate is manufactured by being pressed and molded using engineering plastics as the polymer synthetic resin.

4. The method of claim 1, wherein the back plate and the friction material are pressed and molded with the intermediate plate therebetween and is thermally treated at a set temperature for a set time to manufacture the brake pad in which the back plate, the intermediate plate, and the friction material are integrally coupled to each other.

5. The method of claim 1, wherein the intermediate plate comprises:
a front part that is a portion interposed between a surface of the back plate and a surface of the friction material; and
a side surface cover part integrally disposed along an entire circumference of an edge of the front part to cover a surface of the front part on the entire circumferential of the edge of the back plate,
wherein a cross-section of the front part, on which the surface of the back plate and the surface of the friction material are bonded to be in close contact with each other, has a shape in which a concave-convex shaped part is repeated to increase in bonding force between the surface of the back plate and the surface of the fraction material.
